(19) United States
(12) Patent Application Publication
(10) Pub. No.: US 2026/0212296 A1
(43) Pub. Date: Jul. 23, 2026

(54) SYNDICATION TASK PRIORITIZATER

(71) Applicant: Kenvue Brands LLC, Summit, NJ (US)

(72) Inventors: Alexandria C. Genovese, Philadelphia, PA (US); Claryssa C. Almada, Tucson, AZ (US); Kaitlyn C. McKee, Jersey City, NJ (US); Eric Alan Tarnowski, Doylestown, PA (US); Lauren A. Westin, Jacksonville Beach, FL (US)

(21) Appl. No.: 19/440,865

(22) Filed: Jan. 6, 2026

Related U.S. Application Data
(60) Provisional application No. 63/748,507, filed on Jan. 23, 2025.

(51) Int. Cl. G06Q 10/0631; G06Q 10/0639

(52) U.S. Cl. CPC G06Q 10/06316; G06Q 10/0639

(57) ABSTRACT

Systems and methods for prioritizing and executing syndication tasks. The method includes receiving a syndication request; generating, for the syndication request, a strategic alignment score; generating, for the syndication request, an operational impact score; generating, for the syndication request, a prioritization output based on the generated strategic alignment score and generated operational impact score; and based on the generated prioritization output, assigning the received syndication request to a wave in a queue of requests.

### CROSS-REFERENCE TO RELATED APPLICATION

This application claims the benefit of U.S. Provisional Application No. 63/748,507 filed Jan. 23, 2025, the contents of which is incorporated herein by reference in its entirety.

### BACKGROUND

For large organizations, hundreds of syndication tasks may be generated per week. Aligning the pipeline of syndicated tasks has multiple pain points, most notably the excessive processing time and power spent processing lower-value requests due to a lack of prioritization processes that leads to first-in, first-out processing. This results in lower-priority tasks being executed and performed while higher-priority tasks remain incomplete and in a queue of tasks.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various implementations of the present disclosure described herein are directed to systems and methods that prioritize syndicated tasks. In one implementation, a system is provided. The system includes a memory and a processor. The processor is coupled to the memory and configured to receive a syndication request; generate, for the received syndication request, a strategic alignment score; generate, for the received syndication request, an operational impact score; generate, for the received syndication request, a prioritization output based on the generated strategic alignment score and generated operational impact score; and based on the generated prioritization output, assign the received syndication request to a wave in a queue of requests.

In another implementation, a computer-implemented method is provided. The method includes receiving a syndication request; generating, for the received syndication request, a strategic alignment score; generating, for the received syndication request, an operational impact score; generating, for the received syndication request, a prioritization output based on the generated strategic alignment score and generated operational impact score; generating a visualization of the generated prioritization output; based on the generated prioritization output, assigning the received syndication request to a wave in a queue of requests; and outputting the generated prioritization output and the queue of requests.

In another implementation, one or more non-transitory computer readable media storing instructions is provided. The instructions, when executed by a processor, cause the processor to receive a syndication request, wherein the received syndication request is associated with at least one of a brand, a retailer, and a product; generate, for the received syndication request, a strategic alignment score; generate, for the received syndication request, an operational impact score; generate, for the received syndication request, a prioritization output based on the generated strategic alignment score and generated operational impact score; and generate a visualization of the generated prioritization output, wherein the generated visualization includes a range of strategic alignment scores, a range of operational impact scores, and a plurality of waves based on the range of strategic alignment scores and the range of operational impact scores; based on the generated prioritization output, assign the received syndication request to a wave in a queue of requests; and output, to an interface, the generated prioritization output and the queue of requests.

### BRIEF DESCRIPTION OF THE DRAWINGS

The present description will be better understood from the following detailed description read in light of the accompanying drawings, wherein:

FIG. 1 illustrates an example system for prioritizing syndication tasks according to an example;

FIG. 2 illustrates an example visualization that shows various waves for tasks based on strategic alignment and operational impact according to an example;

FIG. 3 illustrates an example computer-implemented method of prioritizing syndication tasks according to an example;

FIG. 4 illustrates an example computer-implemented method of generating a strategic alignment score according to an example;

FIG. 5 illustrates an example computer-implemented method of generating an operational impact score according to an example; and

FIG. 6 is a block diagram illustrating an example computing environment suitable for implementing one or more of the various examples disclosed herein.

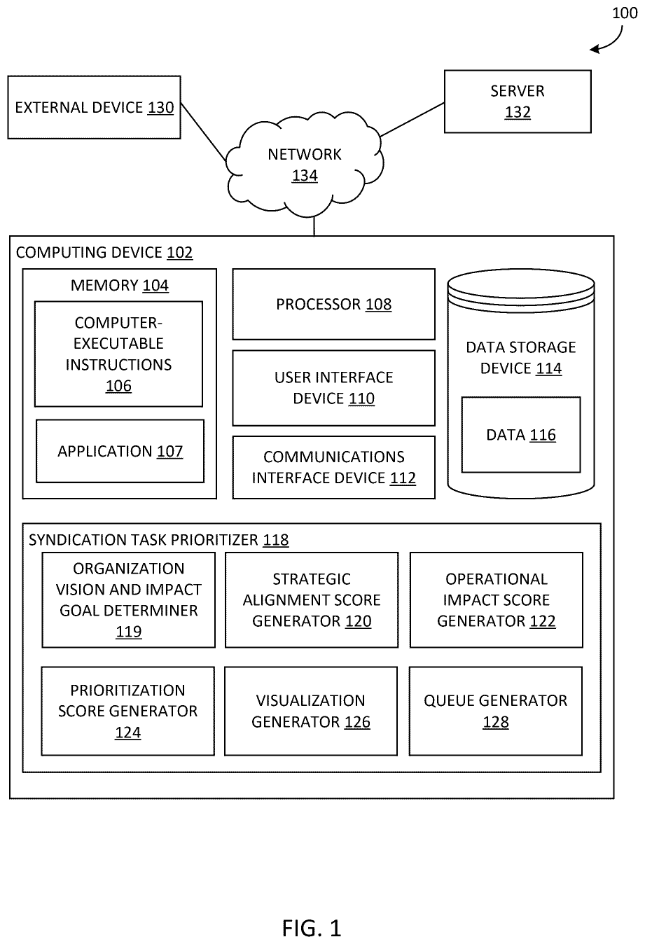

Corresponding reference characters indicate corresponding parts throughout the drawings. In FIGS. 1 to 6, the systems are illustrated as schematic drawings. The drawings may not be to scale.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

As referenced herein, aligning the pipeline of syndicated tasks has significant pain points, for example the excessive processing time and power spent processing lower-value requests due to a lack of prioritization processes that leads to first-in, first-out processing. Current solutions, such as first-in, first-out processing, place received requests in a queue based on the time the requests were received without consideration of details of the request itself. This frequently leads to requests that otherwise would be assigned a lower priority or that take a greater amount of time being processed prior to requests with a higher priority or that could be addressed in a shorter amount of time. In other words, time is spent over-allocating time on lower-value requests and/or requests that are not aligned with organizational-wide priorities.

Various examples of the present disclosure recognize and take into account these challenges and provide systems and methods that generate a queue of received syndication requests based on how the received syndication request strategically aligns with the organization and the potential operational impact of the subject matter of the request. Accordingly, the examples of the present disclosure provide a generated queue of received syndication requests that maximizes the organizational impact of addressing various requests by assigning each request a wave, and generating the queue based on the requests assigned to each wave.

The systems and methods for prioritizing syndications tasks operates in an unconventional manner by identifying organizational vision and impact goals for a particular organization and generating a bespoke queue of incoming requests associated with syndication tasks based on the strategic alignment of the task with the organizational vision and the operational impact of the task based on the goals of the organization. To do so, the systems and methods of the present disclosure generate a strategic alignment score and an operational impact score for the request, generate a prioritization score for the request based on the generated strategic alignment score and operational impact score, assign the request to a wave of requests based on the generated prioritization score, generate the queue of requests based on the assigned waves and prioritization scores of multiple requests, and output the generated queue and visualization of the requests.

Furthermore, the systems and methods for prioritizing syndications tasks provides a technical solution to the inherently technical problem of network inefficiencies and inefficient consumption of computing resources inherent in current task prioritization systems. Current systems consume computing resources in an inefficient manner by addressing tasks as they are received as requests, resulting in resources being consumed for the resolution of tasks that have a low operational impact and/or low strategic alignment to the organization's needs. The systems and methods described herein provide a technical solution to this inherently technical problem by identifying and executing the tasks associated with particular requests that have the greatest operational impact to the organization, the highest strategic alignment with the vision of the organization, or both, and diverting resources away from lower-priority tasks that have one or both of a low operational impact to the organization or a low strategic alignment with the vision of the organization.

FIG. 1 illustrates an example system for performing a process for prioritizing syndication tasks according to an example. The system 100 illustrated in FIG. 1 is provided for illustration only. Other examples of the system 100 may be used without departing from the scope of the present disclosure.

The system 100 includes a computing device 102, an external device 130, a server 136, and a network 138. The computing device 102 represents any device executing computer-executable instructions 106 (e.g., as application programs, operating system functionality, or both) to implement the operations and functionality associated with the computing device 102. The computing device 102 in some examples includes a mobile computing device or any other portable device. A mobile computing device includes, for example but without limitation, a mobile telephone, laptop, tablet, computing pad, netbook, gaming device, and/or portable media player. The computing device 102 may also include less-portable devices such as servers, desktop personal computers, kiosks, or tabletop devices. Additionally, the computing device 102 may represent a group of processing units or other computing devices.

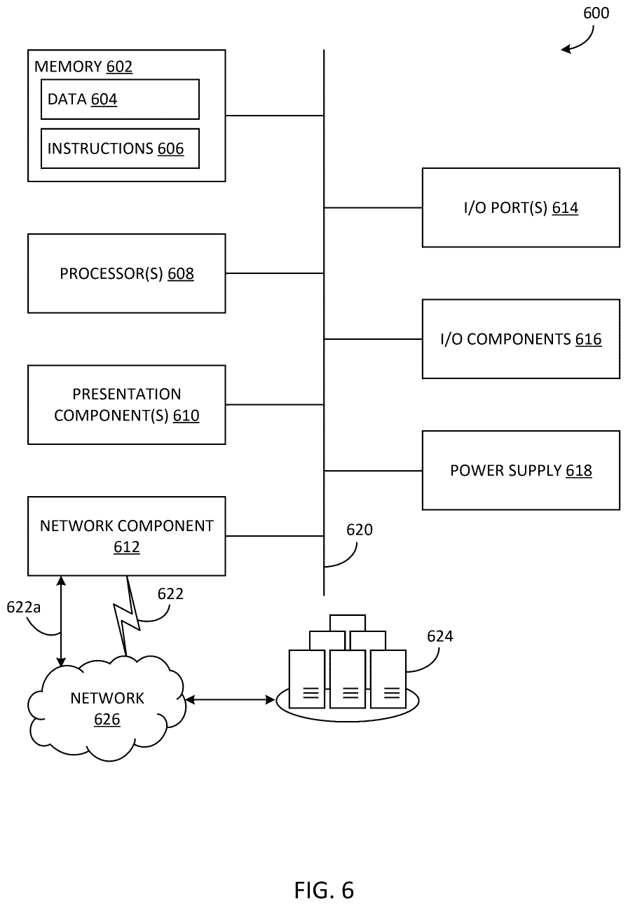

In some examples, the computing device 102 includes at least one processor 108, a memory 104 that includes the computer-executable instructions 106, and a user interface device 110. The processor 108 includes any quantity of processing units and is programmed to execute the computer-executable instructions 106. The computer-executable instructions 106 are performed by the processor 108, performed by multiple processors within the computing device 102, or performed by a processor external to the computing device 102. In some examples, the processor 108 is programmed to execute computer-executable instructions 106 such as those illustrated in the figures described herein, such as FIG. 6. In various examples, the processor 108 is configured to execute computer-executable instructions of the syndication task prioritizer 118.

The memory 104 includes any quantity of media associated with or accessible by the computing device 102. In some examples, the memory 104 is internal to the computing device 102. In other examples, the memory 104 is external to the computing device 102 or both internal and external to the computing device 102. For example, the memory 104 may include both a memory component internal to the computing device 102 and a memory component external to the computing device 102, such as the server 132. The memory 104 stores data, such as one or more applications 107. The applications 107, when executed by the processor 108, operate to perform various functions on the computing device 102. The applications 107 may communicate with counterpart applications or services, such as web services accessible via the network 134. In an example, the applications 107 represent server-side services of an application executing in a cloud, such as a cloud server 132. In some examples, the application 107 is an application for prioritizing syndication tasks as described herein.

The user interface device 110 includes a graphics card for displaying data to a user and receiving data from the user. The user interface device 110 may also include computer-executable instructions, for example a driver, for operating the graphics card. Further, the user interface device 110 may include a display, for example a touch screen display or natural user interface, and/or computer-executable instructions, for example a driver, for operating the display. The user interface device 110 may also include one or more of the following to provide data to the user or receive data from the user: speakers, a sound card, a camera, a microphone, a vibration motor, one or more accelerometers, a BLUETOOTH® communication module, global positioning system (GPS) hardware, and a photoreceptive light sensor. In a non-limiting example, the user inputs commands or manipulates data by moving the computing device 102 in one or more ways.

The computing device 102 further includes a communications interface device 112. The communications interface device 112 includes a network interface card and/or computer-executable instructions, such as a driver, for operating the network interface card. Communication between the computing device 102 and other devices, such as but not limited to the user device 136, may occur using any protocol or mechanism over any wired or wireless connection.

The computing device 102 further includes a data storage device 114 for storing data 116. The data 116 includes, but is not limited to, details associated with a received request, a generated queue of requests, an index or matrix identifying details and prioritization of one or more of retailers, brands, products, request types, content types, and so forth, determined organization vision and impact goals, and so forth.

The computing device further includes a syndication task prioritizer 118. The syndication task prioritizer 118 is an example of a specialized processing unit, implemented on the processor 108, that performs one or more specialized processing functions. The syndication task prioritizer 118 includes an organization vision and impact goal determiner 119, a strategic alignment generator 120, an operational impact score generator 122, a prioritization generator 124, and a visualization score generator 126. Each of the organization vision and impact goal determiner 119, strategic alignment generator 120, operational impact score generator 122, prioritization generator 124, and visualization score generator 126 are further examples of specialized processing units that perform specialized function to prioritize syndicated tasks which are received as requests.

The organization vision and impact goal determiner 119 is an example of a specialized processing unit, implemented on the processor, that determines organizational vision and impact goals. The organization vision is an organizational strategy against which particular syndication tasks can be measured. In some examples, the organizational vision includes particular brands, products, retailers, regions, and so forth and combinations of the same that are most important to organizational growth and/or stability. Each or brands, products, retailers, and regions may be separated into tiered priorities, such as top, middle, bottom, or high, medium, low, and so forth. The impact goals include particular objectives, such as e-commerce objectives, and include request types and impacted content associated with the received request. In some examples, request types are defined as critical, very high, high, medium, medium low, low, and so forth, and impacted content includes a highest impact, high impact, medium impact, low impact, and so forth. It should be understood that each or all of the brands, products, retailers, regions, request types, and impact content may have more or fewer tiers than described herein. These examples are presented for illustration only and should not be construed as limiting.

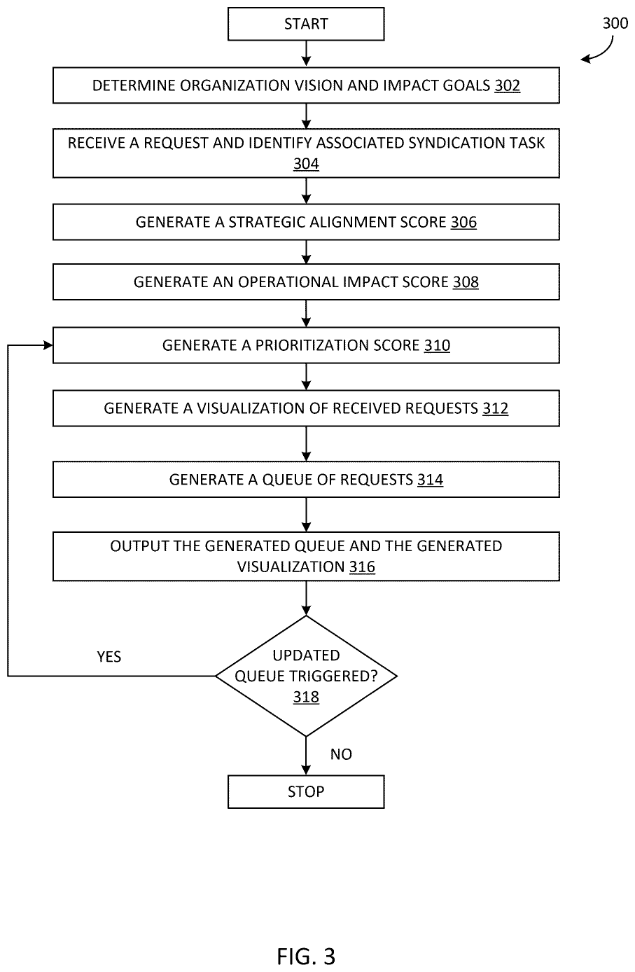

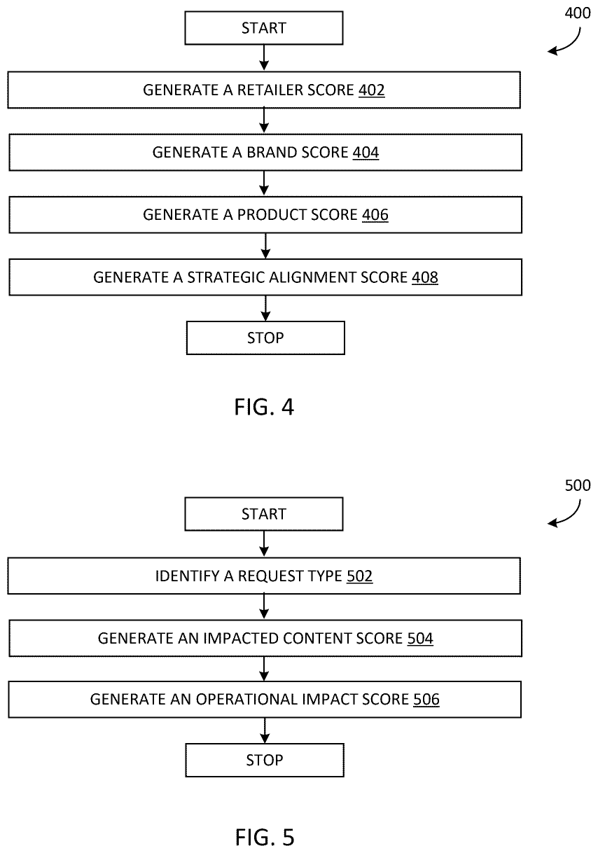

The strategic alignment score generator 120 is an example of a specialized processing unit, implemented on the processor, that generates a strategic alignment score for a received request for a syndication task. The strategic alignment score is a score measuring to what degree the received request aligns with organizational priorities as determined by the organization vision and impact goal determiner 119, based on the retailer associated with the received request, the brand associated with the received request, and the product associated with the received request. The strategic alignment score generator 120 generates an individual score for each of the retailer, the brand, and the product and then generates a composite score based on each of the generated individual scores that measures to what degree the received request aligns with the organizational priorities. The strategic alignment score generator 120 is described in greater detail below with reference to FIGS. 3 and 4.

The operational impact score generator 122 is an example of a specialized processing unit, implemented on the processor, that generates an operational impact score for a received request for a syndication task. The operational impact score is a score measuring the potential operational impact, as determined by the organization vision and impact goal determiner 119, of the syndication task associated with the received request based on the request type of the received request and the potentially impacted content of the received request. The operational impact score generator 122 generates an individual score for each of the request type and the potentially impacted content and then generates a composite score based on each of the generated individual scores that measures the potential operational impact of the syndication task. The operational impact score generator 122 is described in greater detail below with reference to FIGS. 3 and 5.

The prioritization generator 124 is an example of a specialized processing unit, implemented on the processor, that generates a prioritization score for the received request based on the generated strategic alignment score and the generated operational impact score. In some examples, the generated prioritization score is expressed as a ratio that measures the generated strategic alignment score and the generated operational impact score. In some examples, the generated prioritization score is expressed as a numerical or alphabetical value indicating a priority of the request. For example, a priority #1 request may be a highest priority, a priority #2 request may be a high priority but lower priority than a priority #1 request, a priority #3 request may be a lower priority request than either priority #1 or priority #2, and so forth. In some examples, the generated priority score is converted to an assignment of a wave value, which indicates a priority of the received request. In some examples, the generated priority score is initially expressed as the wave value.

The visualization score generator 126 is an example of a specialized processing unit, implemented on the processor, that generates a visualization of all received requests based on combinations of operational impact scores and strategic alignment scores. In some examples, the visualization is a matrix identifying, for each combination of potential operational impact scores and strategic alignment scores, to which wave, or priority, the received request will be assigned. In some examples, the visualization is presented on the user interface device 110, an external device 130, or another device.

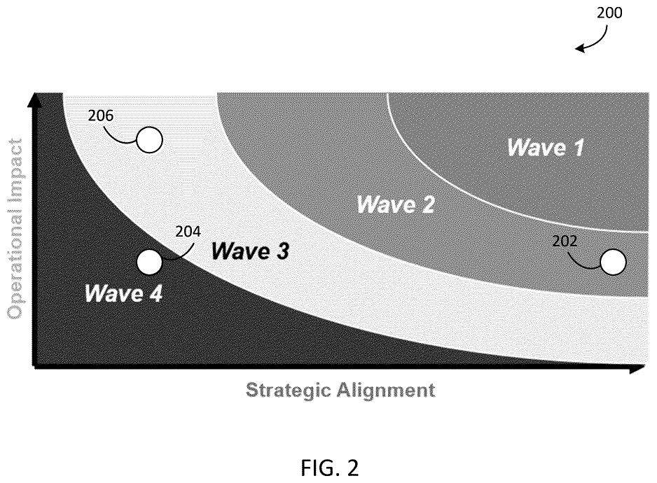

For example, FIG. 2 illustrates an example visualization that shows various waves for tasks based on strategic alignment and operational impact according to an example. The example visualization illustrated in FIG. 2 is presented for illustration only and should not be construed as limiting. Various examples of the example visualization 200 illustrated in FIG. 2 may be used without departing from the scope of the present disclosure.

The example visualization 200 illustrates a graph with strategic alignment scores on the x-axis and operational impact scores on the y-axis. The visualization 200 illustrates four waves: Wave 1, Wave 2, Wave 3, and Wave 4. Each of the waves represent varying degrees of priority for received requests in the waves, where Wave 1 includes the highest priority requests, Wave 2 includes the second highest priority requests, and so forth. Although illustrated in FIG. 2 as including four waves, various examples of the visualization 200 may include more or fewer than four waves. The visualization 200 includes Wave 1, representing the highest priority requests, in the upper-right hand corner where the highest strategic alignment scores intersect the highest operational impact scores. Accordingly, Wave 1 illustrates that the received requests identified as having the highest priority are those which are identified as having a high operational impact as well as being strategically aligned to the organization's goals. Conversely, Wave 4, representing the lowest priority requests, are illustrated in the visualization 200 expanding from the lower left-hand corner, where the lowest strategic alignment scores intersect the lowest operational impact scores. Accordingly, Wave 4 illustrates that the received requests identified as having the lowest priority are those which are identified as having the lowest operational impact, the lowest strategic alignment to the organization's goals, and/or a combination of these. Wave 3 is shown as representing the received requests having a higher priority than those in Wave 4, and Wave 2 is shown as representing the received requests having a higher priority than those in Wave 3, but lower than those in Wave 1.

In some examples, a Wave 1 request is a request to refresh feature bullets associated with a top retailer, a top brand, and a top product with high sales. In another example, a Wave 1 request is a request for a new product setup associated with a top retailer, a top brand, and a highly impactful request type. In some examples, a Wave 2 request is a request to refresh all images on a retailer website for a top retailer, a top brand, and a product with medium sales. In another example, a Wave 2 request is a request for a new product setup associated with a lower-tier retailer, a top brand, and a highly impactful request type. In some examples, a Wave 3 request is a request to build new enhanced content for a top system, a top brand, and a low priority request type. In another example, a Wave 3 request is a request to upload a video file for a top retailer, a top brand, and a low impact request and content type. In some examples, a Wave 4 request is a request to upload images for a lower-tier retailer, a top brand, and a lowest impact request and content type. In another example, a Wave 4 request is a request to validate images are live on the side of a top retailer, for a top brand, having a lowest impact request and content type.

The visualization 200 further illustrates the range of effect of a particular strategic alignment score or operational impact score on the ultimate prioritization of a received request. For example, the visualization 200 illustrates a first received request 202 with a high strategic alignment score and a medium-level operational impact score. The high strategic alignment score is given greater weight to the overall prioritization of the received request, and the task associated with the received request is assigned a prioritization of Wave 2, despite the medium-level operational impact. In comparison, a second received request 204, having the same operational impact of the first received request 202, has a low strategic alignment score. This results the task associated with the second received request 204 being assigned a prioritization of Wave 4, as the operational impact is not high and the strategic alignment of the request to the organization is low. Finally, a third received request 206 has the same low strategic alignment as the second received request 204, but a high operational impact. Due to the increased operational impact, relative to the second received request 204, the task associated with the third received request is assigned a prioritization of Wave 3, greater than the second received request 204.

The queue generator 128 is an example of a specialized processing unit, implemented on the processor, that generates a queue of one or more received requests based on the generated prioritization score of each respective received request. In some examples, the queue is generated by identifying each received request in each wave, e.g., Wave 1, Wave 2, and so forth until Wave n, and placing each received request from Wave 1 first in the queue, each received request from Wave 2 in the queue after each request from Wave 1, and so forth until each received request is included in the queue. The queue generator 128 further generates an order for the requests in a particular wave. In some examples, the queue generator 128 generates the order for the requests in a wave based on the time in which the requests are received. For example, each received request assigned to Wave 1 is ordered such that the earliest received Wave 1 request is first in the queue of Wave 1 requests, the next earliest received Wave 1 request is second in the queue of Wave 1 requests, and so forth. In other examples, the queue generator 128 generates the order for the requests in a wave strictly by the generated prioritization score for the received requests. For example, the highest prioritization score is placed first in the queue of Wave 1 requests, the second highest prioritization score is placed second in the queue of Wave 1 requests, and so forth.

The external device 130 is another example of a computing device, separate from and external of the computing device 102. In some examples, the external device 130 includes a mobile computing device or any other portable device. A mobile computing device includes, for example but without limitation, a mobile telephone, laptop, tablet, computing pad, netbook, gaming device, and/or portable media player. The external device 130 may also include less-portable devices such as servers, desktop personal computers, kiosks, or tabletop devices. Additionally, the external device 130 may represent a group of processing units or other computing devices. The server 132, in some examples, is an example of an external storage device, remote data storage device, a data storage in a remote data center, or a cloud storage. The external device 130 and/or the server 132 communicate with the computing device 102 via the network 134.

FIG. 3 illustrates an example computer-implemented method of prioritizing syndication tasks according to an example. The computer-implemented method 300 is presented for illustration only and should not be construed as limiting. Other examples of the computer-implemented method 300 can be used without departing from the scope of the present disclosure. The computer-implemented method 300 can be implemented by one or more electronic devices described herein, such as the computing device 102.

The computer-implemented method 300 begins by the organization vision and impact goal determiner 119 determining an organization vision and impact goals in operation 302. The organization vision is an organizational strategy against which particular syndication tasks can be measured. In some examples, the organizational vision includes particular brands, products, retailers, regions, and so forth and combinations of the same that are most important to organizational growth and/or stability. Each or brands, products, retailers, and regions may be separated into tiered priorities, such as top, middle, bottom, or high, medium, low, and so forth. The impact goals include particular objectives, such as e-commerce objectives, and include request types and impacted content associated with the received request. In some examples, request types are defined as critical, very high, high, medium, medium low, low, and so forth, and impacted content includes a highest impact, high impact, medium impact, low impact, and so forth. It should be understood that each or all of the brands, products, retailers, regions, request types, and impact content may have more or fewer tiers than described herein. These examples are presented for illustration only and should not be construed as limiting.

In operation 304, the syndication task prioritizer 118 receives a request and identifies a syndication task associated with the received request. In some examples, the request is received via the user interface device 110. In some examples, the request is received from an external device, such as the external device 130, via the communications interface device 112. In some examples, the received request is a request for a task, such as a syndication task, to be performed by an organization. Various examples of tasks include refreshing images on the website of a retailer for a particular product, building new content for a retailer for a particular product, uploading images and/or videos for a retailer for a product, refreshing feature bullets on a retailer's website for a product, setting up a new product at a retailer for a product, validating images are live on a retailer's website for a product, and so forth.

In operation 306, the strategic alignment score generator 120 generates a strategic alignment score for the received request. In some examples, the strategic alignment score generator 120 generates a retailer score, a brand score, and a product score for the received request and then, based on each of the generated scores, generates a comprehensive strategic alignment score for the received request. The generation of the strategic alignment score is described in greater detail below with regards to FIG. 4.

In operation 308, the operational impact score generator 122 generates an operational impact score for the received request. In some examples, the operational impact score generator 122 generates a request type and an impacted content score for the received request and then, based on each of the generated scores, generates a comprehensive operational impact score for the received request. The generation of the operational impact score is described in greater detail below with regards to FIG. 5.

Although operations 306 and 308 are described herein as occurring in sequence, various examples are possible without departing from the scope of the present disclosure. In various examples, operation 306 may be performed prior to operation 308, operation 308 may be performed prior to operation 306, or operations 306 and 308 may be performed simultaneously.

In operation 310, the prioritization generator 124 generates a prioritization score for the received request based on the generated strategic alignment score and the generated operational impact score. As referenced herein, the prioritization score may be expressed in various ways. For example, the prioritization score may be expressed as a ratio that measures the generated strategic alignment score and the generated operational impact score, as a numerical or alphabetical value indicating a priority of the request, or initially expressed as the wave value. In operation 312, the visualization score generator 126 generates a visualization of the received request. For example, based on the generated prioritization score, the visualization score generator 126 places the received request on a matrix, which identifies a wave to which the particular received request is assigned. The generated visualization includes the received request and each wave of potential requests.

In operation 314, the queue generator 128 generates a queue of one or more received requests based on the based on the generated prioritization score of each respective received request. In some examples, the queue is generated by identifying each received request in each wave, e.g., Wave 1, Wave 2, and so forth until Wave n, and placing each received request from Wave 1 first in the queue, each received request from Wave 2 in the queue after each request from Wave 1, and so forth until each received request is included in the queue. The queue generator 128 further generates an order for the requests in a particular wave. In some examples, the queue generator 128 generates the order for the requests in a wave based on the time in which the requests are received. For example, each received request assigned to Wave 1 is ordered such that the earliest received Wave 1 request is first in the queue of Wave 1 requests, the next earliest received Wave 1 request is second in the queue of Wave 1 requests, and so forth. In other examples, the queue generator 128 generates the order for the requests in a wave strictly by the generated prioritization score for the received requests. For example, the highest prioritization score is placed first in the queue of Wave 1 requests, the second highest prioritization score is placed second in the queue of Wave 1 requests, and so forth.

In operation 316, the syndication task prioritizer 118 outputs the generated queue of received requests and the generated visualization. In some examples, the generated queue of received requests and the generated visualization are output on the computing device 102 via the user interface device 110. In some examples, the generated queue of received requests and the generated visualization are output to an external device, such as the external device 130, via the communications interface device 112. In some examples, the generated queue of received requests and the generated visualization are output, instead of or in addition to, to the data storage device 114 and/or the server 132 and stored as an example of the data 116.

In operation 318, the syndication task prioritizer 118 determines whether an update to the queue has been triggered. The queue may be triggered to update based on one or more triggering events occurring. For example, the queue may be triggered to update at a regular time interval, such as every hour, every two hours, every twelve hours, every twenty-four hours, or any other such interval. In another example, the queue may be triggered to update in response to a new request, or a threshold number of new requests, being received. In another example, the queue may be triggered to update in response to a task, or a threshold number of tasks, associated with received requests in the queue being completed and removed from the queue. In examples where the syndication task prioritizer 118 determines an update to the queue has been triggered, the computer-implemented method 300 returns to operation 310 and generates a new prioritization score and reassigns the received syndication request to a new wave in the queue of requests and then, in operation 312, generates a new visualization of received requests. In examples where the syndication task prioritizer 118 determines an update to the queue has not been triggered, the computer-implemented method 300 terminates.

As referenced herein, the generated prioritization score and generated visualization of the prioritization score, including the matrix of waves of priorities and requests associated with the respective priorities, improves network efficiencies and resource consumption. Rather than addressing tasks on a rolling basis as they are received, which otherwise could result in the higher prioritization of lower-impact requests due simply to a temporal factor, tasks deemed to have a higher operational impact and/or strategic alignment with the vision of the organization are prioritized and addressed. Furthermore, the regular updates to the generated prioritization score and generated visualization of the prioritization score based on predetermined triggers further enables the priorities of different requests to be regularly re-evaluated and prioritized to enable further improve network efficiencies and resource consumption.

FIG. 4 illustrates an example computer-implemented method of generating a strategic alignment score according to an example. The computer-implemented method 400 is presented for illustration only and should not be construed as limiting. Other examples of the computer-implemented method 400 can be used without departing from the scope of the present disclosure. The computer-implemented method 400 can be implemented by one or more electronic devices described herein, such as the strategic alignment score generator 120 implemented on the computing device 102.

The computer-implemented method 400 begins by the strategic alignment score generator 120 generating a retailer score for a received request in operation 402. The retail score is generated in order to quantify an importance of the retailer involved in the received request. In some examples, where a higher retail score indicates a higher importance, a retailer who is determined to be of a high importance to the organization receiving the request is given a higher retailer score than a retailer who is determined to be of a low importance. In some examples, where a lower retail score indicates a higher importance, a retailer who is determined to be of a high importance to the organization receiving the request is given a lower retailer score than a retailer who is determined to be of a low importance. In some examples, an index, or matrix, that identifies importance, or prioritization, for each associated retailer is maintained as an example of data 116 stored in the data storage device 114 and/or on the server 132. The retailer score may be provided as a numerical score on a scale of one to three, one to five, one to six, one to ten, or any other suitable scale.

In operation 404, the strategic alignment score generator 120 generates a brand score for the received request. The brand score is generated in order to quantify an importance of the brand involved in the received request. In some examples, where a higher brand score indicates a higher importance, a brand who is determined to be of a high importance to the request is given a higher brand score than a brand who is determined to be of a low importance. In some examples, where a lower brand score indicates a higher importance, a brand who is determined to be of a high importance to the request is given a lower brand score than a brand who is determined to be of a low importance. In some examples, an index, or matrix, that identifies importance, or prioritization, for each associated brand is maintained as an example of data 116 stored in the data storage device 114 and/or on the server 132. The brand score may be provided as a numerical score on a scale of one to three, five, one to six, one to ten, or any other suitable scale.

In operation 406, the strategic alignment score generator 120 generates a product score for a received request. The product score is generated in order to quantify an importance of the product involved in the received request. In some examples, the product score is a combination of a strategic position of the product and retail performance of the product. In some examples, the strategic position of the product is determined based on a combination of SKU Portfolio Optimization Model (POM) segmentation and retailer priority. Retailer priority may be determined as a binary value, such as zero or one, zero or two, and so forth. POM segmentations may be a weighted score provided on a scale of one to three, one to four, one to five, or any other suitable scale. POM segmentation includes a combination of organizational POM and retailer POM, which are added or averaged together to generate the POM segmentation value.

In operation 408, the strategic alignment score generator 120 generates a comprehensive strategic alignment score for the received request. In some examples, the comprehensive strategic alignment score is generated by adding together the generated retailer score, brand score, and product score. In some examples, the comprehensive strategic alignment score is generated by averaging the generated retailer score, brand score, and product score together. In some examples, the comprehensive strategic alignment score is generated by combining the generated retailer score, brand score, and product score together such that each score is given a particular weight. For example, the brand may be given a greater weight than the retailer and product, the product may be given a greater weight than the brand and retailer, the retailer may be given a greater weight than the brand and product, and so forth.

In some examples, a higher comprehensive strategic alignment score indicates a greater strategic alignment score, which in turn indicates that the syndicated task associated with the received request has a high strategic alignment with the organization. In other examples, a lower comprehensive strategic alignment score indicates a higher strategic alignment score, which in turn indicates that the syndicated task associated with the received request has a high strategic alignment with the organization. Following the comprehensive strategic alignment score being generated in operation 408, the computer-implemented method 400 terminates.

FIG. 5 illustrates an example computer-implemented method of generating an operational impact score according to an example. The computer-implemented method 500 is presented for illustration only and should not be construed as limiting. Other examples of the computer-implemented method 500 can be used without departing from the scope of the present disclosure. The computer-implemented method 500 can be implemented by one or more electronic devices described herein, such as the operational impact score generator 122 implemented on the computing device 102.

The computer-implemented method 500 begins by the operational impact score generator 122 identifying a request type in operation 502. The request type is identified in order to determine the type of task associated with the received request and determine. As described herein, various examples of tasks include refreshing images on the website of a retailer for a particular product, building new content for a retailer for a particular product, uploading images and/or videos for a retailer for a product, refreshing feature bullets on a retailer's website for a product, setting up a new product at a retailer for a product, validating images are live on a retailer's website for a product, and so forth. It should be understood these examples are presented for illustration only and should not be construed as limiting. Various examples of tasks may be associated with a request without departing from the scope of the present disclosure.

In some examples, each example of a request is associated with a predetermined request score. In some examples, where a higher request score indicates a higher importance, a task associated with the request that is determined to be of a high importance is given a higher request score than a request which is determined to be of a low importance. In some examples, where a lower request score indicates a higher importance, a task associated with the request that is determined to be of a high importance to the request is given a lower request score than a request which is determined to be of a low importance. In some examples, an index, or matrix, that identifies importance, or prioritization, for each associated request is maintained as an example of data 116 stored in the data storage device 114 and/or on the server 132. The request score may be provided as a numerical score on a scale of one to three, five, one to six, one to eight, one to ten, or any other suitable scale.

In operation 504, the operational impact score generator 122 generates an impacted content score. The impacted content score is generated in order to quantify an importance of the content to be impact by the executed of the task associated with the received request. In some examples, where a higher impacted content score indicates a higher importance, content associated with the request that is determined to be of a high importance is given a higher impacted content score than a request which is determined to be of a low importance. In some examples, where a lower impacted content score indicates a higher importance, content associated with the request that is determined to be of a high importance to the request is given a lower impacted content score than a request which is determined to be of a low importance. In some examples, an index, or matrix, that identifies importance, or prioritization, for various types of content is maintained as an example of data 116 stored in the data storage device 114 and/or on the server 132. The impacted content score may be provided as a numerical score on a scale of one to three, five, one to six, one to eight, one to ten, or any other suitable scale.

In operation 506, the operational impact score generator 122 generates a comprehensive operational impact score based on the identified request type and associated request score, and the generated impacted content score. In some examples, the comprehensive operational impact score is generated by adding together the generated request score and the impacted content score. In some examples, the comprehensive operational impact score is generated by averaging the request score and impacted content score together. In some examples, the comprehensive operational impact score is generated by combining the generated request score and the impacted content score together such that each score is given a particular weight. For example, the request may be given a greater weight than the impacted content or the impacted content may be given a greater weight than the request.

In some examples, a higher comprehensive operational impact score indicates a greater operational impact, which in turn indicates that the syndicated task associated with the received request has a high operational impact within the organization. In other examples, a lower comprehensive operational impact score indicates a higher operational impact, which in turn indicates that the syndicated task associated with the received request has a high operational impact within the organization. Following the comprehensive strategic alignment score being generated in operation 506, the computer-implemented method 500 terminates.

### Example Operating Environment

FIG. 6 is a block diagram of an example computing device 600 for implementing aspects disclosed herein and is designated generally as computing device 600. Computing device 600 is an example of a suitable computing environment and is not intended to suggest any limitation as to the scope of use or functionality of the examples disclosed herein. Neither should computing device 600 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 600 includes a bus 620 that directly or indirectly couples the following devices: computer-storage memory 602, one or more processors 608, one or more presentation components 610, I/O ports 614, I/O components 616, a power supply 618, and a network component 612. While computing device 600 is depicted as a seemingly single device, multiple computing devices 600 may work together and share the depicted device resources. For example, memory 602 may be distributed across multiple devices, and processor(s) 608 may be housed with different devices.

Bus 620 represents what may be one or more busses (such as an address bus, data bus, or a combination thereof). Although the various blocks of FIG. 6 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 6 and the references herein to a “computing device.” Memory 602 may take the form of the computer-storage media references below and operatively provide storage of computer-readable instructions, data structures, program modules and other data for computing device 600. In some examples, memory 602 stores one or more of an operating system, a universal application platform, or other program modules and program data. Memory 602 is thus able to store and access data 604 and instructions 606 that are executable by processor 608 and configured to carry out the various operations disclosed herein.

In some examples, memory 602 includes computer-storage media in the form of volatile and/or nonvolatile memory, removable or non-removable memory, data disks in virtual environments, or a combination thereof. Memory 602 may include any quantity of memory associated with or accessible by computing device 600. Memory 602 may be internal to computing device 600 (as shown in FIG. 6), external to computing device 600, or both. Examples of memory 602 include, without limitation, random access memory (RAM); read only memory (ROM); electronically erasable programmable read only memory (EEPROM); flash memory or other memory technologies; CD-ROM, digital versatile disks (DVDs) or other optical or holographic media; magnetic cassettes, magnetic tape, magnetic disk storage or other magnetic storage devices; memory wired into an analog computing device; or any other medium for encoding desired information and for access by computing device 600. Additionally, or alternatively, memory 602 may be distributed across multiple computing devices 600, for example, in a virtualized environment in which instruction processing is carried out on multiple computing devices 600. For the purposes of this disclosure, “computer storage media,” “computer-storage memory,” “memory,” and “memory devices” are synonymous terms for computer-storage memory 602, and none of these terms include carrier waves or propagating signaling.

Processor(s) 608 may include any quantity of processing units that read data from various entities, such as memory 602 or I/O components 616 and may include CPUs and/or GPUs. Specifically, processor(s) 608 are programmed to execute computer-executable instructions for implementing aspects of the disclosure. The instructions may be performed by the processor, by multiple processors within computing device 600, or by a processor external to client computing device 600. In some examples, processor(s) 608 are programmed to execute instructions such as those illustrated in the in the accompanying drawings. Moreover, in some examples, processor(s) 608 represent an implementation of analog techniques to perform the operations described herein. For example, the operations may be performed by an analog client computing device 600 and/or a digital client computing device 600. Presentation component(s) 610 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 600, across a wired connection, or in other ways. I/O ports 614 allow computing device 600 to be logically coupled to other devices including I/O components 616, some of which may be built in. Example I/O components 616 include, for example but without limitation, a microphone, joystick, game pad, satellite dish, scanner, printer, wireless device, etc.

Computing device 600 may operate in a networked environment via network component 612 using logical connections to one or more remote computers. In some examples, network component 612 includes a network interface card and/or computer-executable instructions (e.g., a driver) for operating the network interface card. Communication between computing device 600 and other devices may occur using any protocol or mechanism over any wired or wireless connection. In some examples, network component 612 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 612 communicates over wireless communication link 622 and/or a wired communication link 622a to a cloud resource 624 across network 626. Various different examples of communication links 622 and 622a include a wireless connection, a wired connection, and/or a dedicated link, and in some examples, at least a portion is routed through the internet.

Although described in connection with an example computing device 600, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and are non-transitory, i.e., exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

In one example, a system is provided. The system includes a memory and a processor. The processor is coupled to the memory and configured to receive a syndication request; generate, for the received syndication request, a strategic alignment score; generate, for the received syndication request, an operational impact score; generate, for the received syndication request, a prioritization output based on the generated strategic alignment score and generated operational impact score; and based on the generated prioritization output, assign the received syndication request to a wave in a queue of requests.

In another example, a computer-implemented method is provided. The method includes receiving a syndication request; generating, for the received syndication request, a strategic alignment score; generating, for the received syndication request, an operational impact score; generating, for the received syndication request, a prioritization output based on the generated strategic alignment score and generated operational impact score; generating a visualization of the generated prioritization output; based on the generated prioritization output, assigning the received syndication request to a wave in a queue of requests; and outputting the generated prioritization output and the queue of requests.

In another example, one or more non-transitory computer readable media storing instructions is provided. The instructions, when executed by a processor, cause the processor to receive a syndication request, wherein the received syndication request is associated with at least one of a brand, a retailer, and a product; generate, for the received syndication request, a strategic alignment score; generate, for the received syndication request, an operational impact score; generate, for the received syndication request, a prioritization output based on the generated strategic alignment score and generated operational impact score; and generate a visualization of the generated prioritization output, wherein the generated visualization includes a range of strategic alignment scores, a range of operational impact scores, and a plurality of waves based on the range of strategic alignment scores and the range of operational impact scores; based on the generated prioritization output, assign the received syndication request to a wave in a queue of requests; and output, to an interface, the generated prioritization output and the queue of requests.

Further examples for are described herein.

Various examples further include one or more of the following:
wherein the processor is further configured to: generate a visualization of the generated prioritization output, the generated visualization including a range of strategic alignment scores, a range of operational impact scores, and a plurality of waves based on the range of strategic alignment scores and the range of operational impact scores;
generate the queue of requests, the queue of requests including a plurality of waves, wherein each wave of the plurality of waves is a grouping of one or more received syndication requests grouped by priority;
determine that an update to the generated queue of requests is triggered;
based on the determination, update the generated prioritization output and reassign the received syndication request to a new wave in the queue of requests;
based on the determination, generate a new visualization of the generated prioritization output;
wherein the received syndication request is associated with at least one of a brand, a retailer, and a product;
wherein, to generate the strategic alignment score, the processor is further configured to: generate a retailer score for the received syndication request; generate a brand score for the received syndication request; generate a product score for the received syndication request; and generate the strategic alignment score based on the generated retailer score, the generated brand score, and the generated product score; and
wherein, to generate the operational impact score, the processor is further configured to: identify a request type for the received syndication request; generate an impacted content score for the received syndication request; and generate the operational impact score based on the identified request type and the generated impact content score.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system, comprising:
a memory; and
a processor coupled to the memory and configured to:
receive a syndication request;
generate, for the received syndication request, a strategic alignment score;
generate, for the received syndication request, an operational impact score;
generate, for the received syndication request, a prioritization output based on the generated strategic alignment score and generated operational impact score; and
based on the generated prioritization output, assign the received syndication request to a wave in a queue of requests.

2. The system of claim 1, wherein the processor is further configured to:
generate a visualization of the generated prioritization output, the generated visualization including a range of the strategic alignment scores, a range of the operational impact scores, and a plurality of waves based on the range of the strategic alignment scores and the range of the operational impact scores.

3. The system of claim 2, wherein the processor is further configured to:
generate the queue of requests, the queue of requests including a plurality of waves,
wherein each wave of the plurality of waves is a grouping of one or more received syndication requests grouped by priority.

4. The system of claim 3, wherein the processor is further configured to:
determine that an update to the generated queue of requests is triggered; and
based on the determination, update the generated prioritization output and reassign the received syndication request to a new wave in the queue of requests.

5. The system of claim 4, wherein the processor is further configured to:
based on the determination, generate a new visualization of the generated prioritization output.

6. The system of claim 1, wherein the received syndication request is associated with at least one of a brand, a retailer, and a product.

7. The system of claim 6, wherein, to generate the strategic alignment score, the processor is further configured to:
generate a retailer score for the received syndication request;
generate a brand score for the received syndication request;
generate a product score for the received syndication request; and
generate the strategic alignment score based on the generated retailer score, the generated brand score, and the generated product score.

8. The system of claim 6, wherein, to generate the operational impact score, the processor is further configured to:
identify a request type for the received syndication request;
generate an impacted content score for the received syndication request; and
generate the operational impact score based on the identified request type and the generated impact content score.

9. A computer-implemented method for prioritizing syndicated requests, the computer-implemented method comprising:
receiving a syndication request;
generating, for the received syndication request, a strategic alignment score;
generating, for the received syndication request, an operational impact score;
generating, for the received syndication request, a prioritization output based on the generated strategic alignment score and generated operational impact score;
generating a visualization of the generated prioritization output;
based on the generated prioritization output, assigning the received syndication request to a wave in a queue of requests; and
outputting the generated prioritization output and the queue of requests.

10. The computer-implemented method of claim 9, wherein the generated visualization includes a range of strategic alignment scores, a range of operational impact scores, and a plurality of waves based on the range of strategic alignment scores and the range of operational impact scores.

11. The computer-implemented method of claim 10, further comprising:
generating the queue of requests, the queue of requests including a plurality of waves, wherein each wave of the plurality of waves is a grouping of one or more received syndication requests grouped by priority.

12. The computer-implemented method of claim 11, further comprising:
determining that an update to the generated queue of requests is triggered; and
based on the determination, updating the generated prioritization output and reassign the received syndication request to a new wave in the queue of requests.

13. The computer-implemented method of claim 12, further comprising:
based on the determination, generating a new visualization of the generated prioritization output.

14. The computer-implemented method of claim 9, wherein the received syndication request is associated with at least one of a brand, a retailer, and a product.

15. The computer-implemented method of claim 14, wherein generating the strategic alignment score further comprises:
generating a retailer score for the received syndication request;
generating a brand score for the received syndication request;
generating a product score for the received syndication request; and
generating the strategic alignment score based on the generated retailer score, the generated brand score, and the generated product score.

16. The computer-implemented method of claim 14, wherein generating the operational impact score further comprises:
identifying a request type for the received syndication request;
generating an impacted content score for the received syndication request; and
generating the operational impact score based on the identified request type and the generated impact content score.

17. One or more non-transitory computer readable media storing instructions that, when executed by a processor, cause the processor to:
receive a syndication request, wherein the received syndication request is associated with at least one of a brand, a retailer, and a product;
generate, for the received syndication request, a strategic alignment score;
generate, for the received syndication request, an operational impact score;
generate, for the received syndication request, a prioritization output based on the generated strategic alignment score and generated operational impact score; and
generate a visualization of the generated prioritization output, wherein the generated visualization includes a range of strategic alignment scores, a range of operational impact scores, and a plurality of waves based on the range of strategic alignment scores and the range of operational impact scores;
based on the generated prioritization output, assign the received syndication request to a wave in a queue of requests; and
output, to an interface, the generated prioritization output and the queue of requests.

18. The one or more non-transitory computer readable media of claim 17, further storing instructions that, when executed by the processor, cause the processor to:
generate the queue of requests, the queue of requests including a plurality of waves, wherein each wave of the plurality of waves is a grouping of one or more received syndication requests grouped by priority;
determine that an update to the generated queue of requests is triggered;
based on the determination, update the generated prioritization output and reassign the received syndication request to a new wave in the queue of requests; and
based on the determination, generating a new visualization of the generated prioritization output.

19. The one or more non-transitory computer readable media of claim 17, further storing instructions to generate the strategic alignment score that, when executed by the processor, cause the processor to:
generate a retailer score for the received syndication request;
generate a brand score for the received syndication request;
generate a product score for the received syndication request; and
generate the strategic alignment score based on the generated retailer score, the generated brand score, and the generated product score.

20. The one or more non-transitory computer readable media of claim 17, further storing instructions to generate the operational impact score that, when executed by the processor, cause the processor to:
identify a request type for the received syndication request;
generate an impacted content score for the received syndication request; and
generate the operational impact score based on the identified request type and the generated impact content score.
